(19) United States
(12) Patent Application Publication
(10) Pub. No.: US 2006/0031208 A1
(43) Pub. Date: Feb. 9, 2006

(54) Macro module used in point-to-point distributive system and method for searching and downloading used a web browser as an interface

(76) Inventors: Weber Wu, Taipei (TW); Alin Wu, Taipei (TW); Clark Su, Taipei (TW); Quo-Lung Chang, Taipei (TW)

Correspondence Address: BRUCE H. TROXELL, SUITE 1404, 5205 LEESBURG PIKE, FALLS CHURCH, VA, 22041, US

(21) Appl. No.: 11/151,447

(22) Filed: Jun. 14, 2005

(30) Foreign Application Priority Data
Jul. 20, 2004 (TW) 93121633

(51) Int. Cl. G06F 17/30

(52) U.S. Cl. 707/3

(57) ABSTRACT

A point-to-point distributive search and download system and method using a Web browser as an interface aim to store a comparison keyword in a storage module of a comparison keyword server. The storage module also stores a corresponding mode corresponding to the comparison keyword. The corresponding mode includes a direct download mode, a direct link mode and a direct listing mode. Enter a search keyword from a search terminal, a first comparison module compares the search keyword with the comparison keyword. Based on the comparison result, a second comparison module, a download determination module, a link determination module and a listing determination module perform related functions according to different corresponding modes.

### BACKGROUND OF THE INVENTION

(1) Field of the Invention

The present invention relates to a point-to-point distributive search and download system and method, and particularly to a point-to-point distributive search and download system and method that use a Web browser as an interface.

(2) Description of the Prior Art

Nowadays multimedia contents and Internet technology are developed and flourish continuously. There is a new point-to-point distributive search and download system and method that enable users who want to search a specific multimedia file to directly link to a data terminal corresponding to catalog items by selection from a search terminal through networks that has the collected catalog items displayed, and download the targeted files of the catalog items.

Such an approach can distribute the data transmission workload of the network and enable users to find out the required file easier. However, the present point-to-point distributive search and download system and method still have disadvantages, notably: 1. The interface is a self-setting browser which has to be installed separately. The browser could be different among different vendors. It is difficult for users to adapt quickly. 2. The download mode provides simple and limited functions. Once users enter a keyword, the browser picture displays only the catalog items that contain the keywords, and the files corresponding to the selected catalog items are downloaded. There is no other process mode. 3. At present only the multimedia file can be downloaded. Other types of files on the data terminal cannot be downloaded.

Therefore the primary object of the invention is to provide a point-to-point distributive search and download system and method that use a Web browser as an interface to overcome the aforesaid problems.

### SUMMARY OF THE INVENTION

It is an object of the invention is to provide a point-to-point distributive search and download system and method that use a Web browser as an interface to enable users to easily search and download through the Web browser.

Another object of the invention is to expand multiple process modes such as direct download mode, direct link mode and direct listing mode and the like so that users and service providers (vendors) have multiple choices and business modes.

Yet another object of the invention is to enable a search terminal to download other types of files from data terminals.

The point-to-point distributive search and download system using a Web browser as an interface according to the invention includes a search terminal, a comparison keyword server and at least one data terminal that are interconnected through networks.

In one aspect, the point-to-point distributive search and download system according to the invention further includes a storage module, a catalog generation module, a catalog opening module, a keyword input module, a first comparison module, a second comparison module, a display module, a download determination module, a download linking module, a link determination module, a Web linking module, and a listing determination module. All the aforesaid modules are adaptable to the search terminal, comparison keyword server and data terminal.

The storage module is located in the comparison keyword server to store in advance at least one comparison keyword and a corresponding mode of the comparison keyword. The corresponding mode includes a direct download mode, a direct link mode and a direct listing mode. The direct download mode aims to link the comparison keyword to the data terminal where the corresponding file of the comparison keyword resides. The direct link mode aims to directly link the comparison keyword to a preset Web address. The direct listing mode aims to list catalog items related to the search keyword.

The catalog generation module is installed in the data terminal to generate at least one catalog item according to the file of the data terminal. The catalog opening module is installed in the data terminal to open the catalog item to the networks.

The keyword input module is installed in the search terminal to enter a search keyword.

The first comparison module is installed in the search terminal to compare the search keyword with the comparison keyword.

The second comparison module is installed in the search terminal to compare the search keyword with the catalog items opened by the catalog opening module when the comparison of the search keyword and the comparison keyword performed by the first comparison module does not match.

The display module is installed in the search terminal to display the catalog items that contain the keyword on the Web browser when the comparison of the search keyword and the text of the catalog items performed by the second comparison module matches. Each catalog item displayed by the display module is linked through the network to the data terminal which contains the corresponding file of the catalog item.

The download determination module is installed in the search terminal to compare the comparison keyword of the direct download mode which is the corresponding mode when the comparison of the search keyword and the comparison keyword performed by the first comparison module matches.

The download linking module is installed in the search terminal to directly link to the data terminal which contains a corresponding file of the comparison keyword when the corresponding mode compared by the download determination module is the direct download mode, and transfer the file from the data terminal to the search terminal.

The link determination module is installed in the search terminal to compare the comparison keyword of the direct link mode which is the corresponding mode when the comparison between the search keyword and the comparison keyword performed by the first comparison module matches.

The Web linking module is installed in the search terminal to directly link a preset Web address corresponding to the comparison keyword when the corresponding mode of the comparison keyword is the direct link mode, and display the corresponding Web page of the Web address on the search terminal.

The listing determination module is installed in the search terminal to compare the comparison keyword of the direct listing mode which is the corresponding mode when the comparison of the search keyword and the comparison keyword performed by the first comparison module matches.

When the corresponding mode compared by the listing determination module for the comparison keyword is the direct listing mode, the comparison keyword is treated as the search keyword to allow the second comparison module to compare with the comparison keyword with the catalog items opened by the catalog opening module in the later process. When the comparison of the comparison keyword and the text in the catalog items performed by the second comparison module matches, the display module displays the catalog items that contain the keyword on the Web browser. Each catalog item displayed by the display module is linked to the data terminal which stores the corresponding file of the catalog item through the network.

The catalog generation module, catalog opening module, keyword input module, first comparison module, second comparison module, display module, download determination module, download linking module, link determination module, Web linking module and listing determination module are integrated in a search download macro module. The search download macro module is computer executable machine codes, and located outside the Web browser. The search download macro module may be transmitted through the network and installed on the search terminal and the data terminal, or transmitted through a storage medium and installed on the search terminal and the data terminal.

Therefore, by means of the point-to-point distributive search and download system and method using a Web browser as an interface of the invention, the Web browser may be used as an interface to perform point-to-point distributive search and download functions easily. Moreover, it can be expanded to multiple process modes such as the direct download mode, direct link mode and direct listing mode to provide multiple choices for users and service providers to expand service items and business modes. In addition, through the catalog generation module and catalog opening module, different types of files can be downloaded from the data terminal.

### BRIEF DESCRIPTION OF THE DRAWINGS

The present invention will now be specified with reference to its preferred embodiments illustrated in the drawings, in which

FIG. 1 is a schematic diagram of the point-to-point distributive search and download system of the invention;

FIG. 2 is a schematic diagram of the search and download macro module of the invention;

FIG. 3 is a schematic diagram of the labeling module of the invention;

FIG. 4 is a schematic diagram of the sequencing module of the invention;

FIG. 5 is a schematic diagram for resuming transmission after interruption occurred during file download process according to the invention;

FIG. 6 is a schematic diagram for file downloading according to the invention;

FIG. 7 is a schematic view for automatic starting of a new Web browser according to the invention;

FIG. 8 is a schematic view of a first embodiment of the keyword input module according to the invention;

FIG. 9 is a schematic view of a second embodiment of the keyword input module according to the invention;

FIG. 10 is a process flow chart of the point-to-point distributive search and download method according to the invention;

FIG. 11 is a process flow chart of step S10 of the method according to the invention; and

FIG. 12 is a process flow chart of resuming transmission process after interruption according to the invention.

### DESCRIPTION OF THE PREFERRED EMBODIMENTS

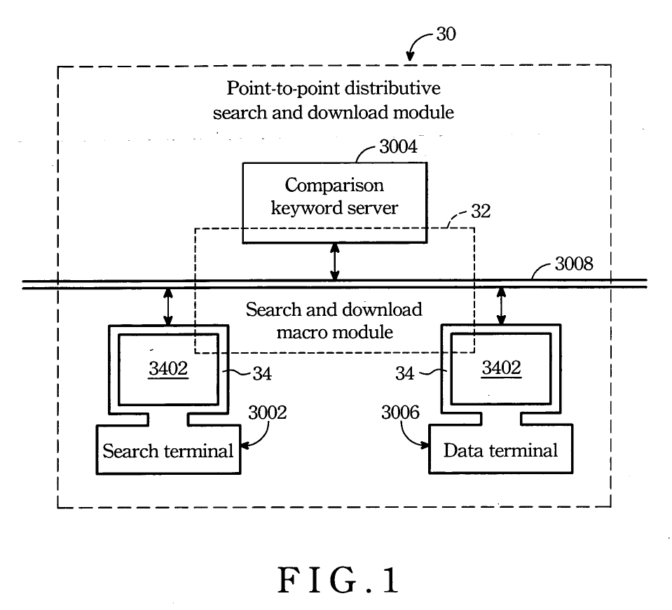

Referring to FIG. 1, the invention aims to provide a point-to-point distributive search and download system 30 that uses a Web browser 3402 as an interface and through a search and download macro module 32 to manage and execute point-to-point distributive search and download functions.

The point-to-point distributive search and download system 30 includes a search terminal 3002, a comparison keyword server 3004 and at least one data terminal 3006 that are interconnected through a network 3008. The search and download macro module 32 is stored respectively in the search terminal 3002, data terminal 3006 and comparison keyword server 3004.

The search and download macro module 32 is computer executable machine codes and located outside the Web browser 3402. The Web browser 3402 may be displayed on the search terminal 3002 and data terminal 3006 through a display device 34. The search and download macro module 32 also may be transmitted through the network 3008 to the search terminal 3002 and data terminal 3006 and installed thereon, or be transported to the search terminal 3002 and data terminal 3006 for installation through a storage medium such as an optical disk, magnetic disk or the like.

For installing outside the Web browser 3402, it is coded in the machine codes by using C or VB program language. In conjunction with the Registry read write mechanism of Windows, the machine codes are stored in a path of HKEY_LOCAL_MACHINE\SOFTWARE\Microsoft\Internet Explorer\Plugins.

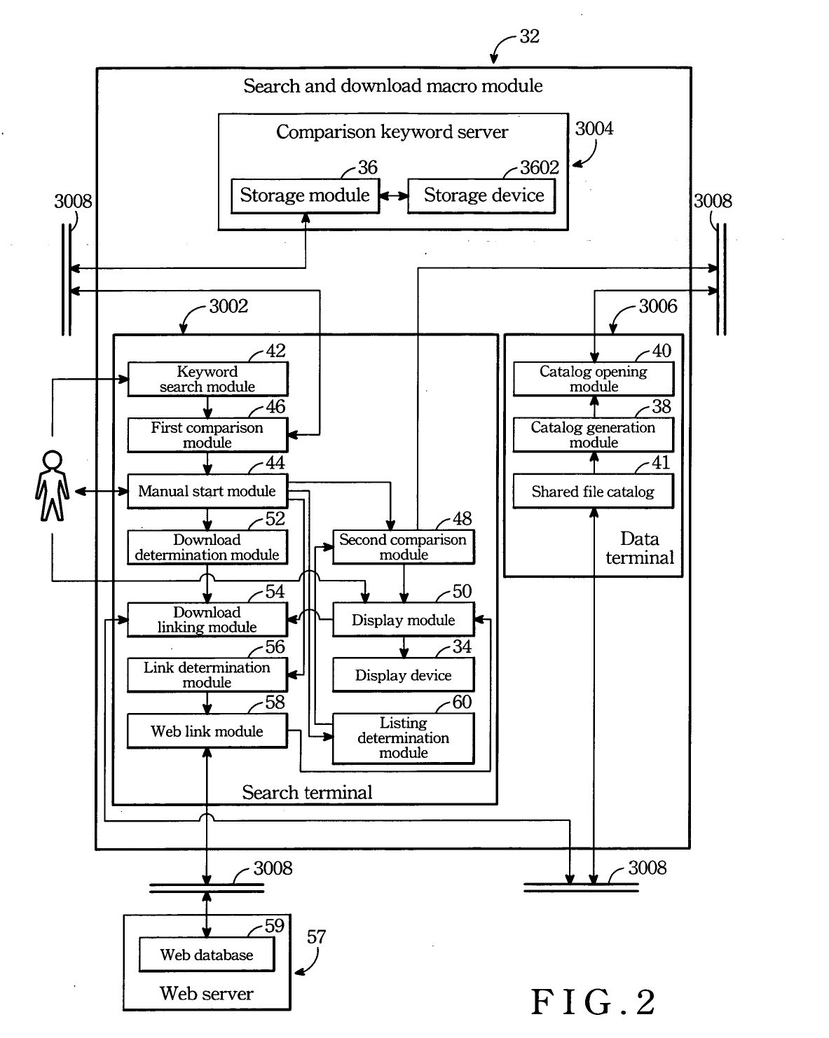

Refer to FIG. 2 for the search and download macro module 32 of the invention. It includes a storage module 36, a catalog generation module 38, a catalog opening module 40, a keyword input module 42, a manual start module 44, a first comparison module 46, a second comparison module 48, a display module 50, a download determination module 52, a download linking module 54, a link determination module 56, a Web link module 58, and a listing determination module 60.

The storage module 36 is used in the comparison keyword server 3004 to store in advance at least one comparison keyword and a corresponding mode of the comparison keyword. They are stored in a storage device 3602 such as hard disk, flash memory and the like. The corresponding mode includes a direct download mode, a direct link mode and a direct listing mode. The direct download mode aims to directly link the comparison keyword to the data terminal 3006 where a corresponding file of the comparison keyword resides. The direct link mode aims to directly link the comparison keyword to a preset Web address. The direct listing mode aims to list catalog items related to the search keyword on the search terminal 3006.

The catalog generation module 38 is used on the data terminal 3006 to generate at least one catalog item according to the file of a shared file catalog 41 on the data terminal 3006. The catalog opening module 40 is used in the data terminal 3006 to open the catalog item to the network 3008.

The method for generating and opening the catalog is discussed further below. As mentioned previously, the machine codes are located outside the Web browser 3402. An instruction is used to set the catalog item to be opened, then the catalog item is opened to the network 3008 through an open instruction.

More details of the method for opening the catalog item through the catalog generation module 38 are elaborated as follow. The catalog opening module 40 aims to open the catalog items on the network 3008, and install the catalog items in the comparison keyword server 3004 to facilitate the search terminal 3002 to gather and download the catalog items from the comparison keyword server 3004. In addition, the catalog opening module 40 can also open the catalog items on the network 3008, and install the catalog items on other data terminal 3006 to enable the search terminal 3002 to download the catalog items from a plurality of data terminals 3006 in a distributive fashion.

The keyword input module 42 is used on the search terminal 3002 to enter a search keyword.

The first comparison module 46 is used on the search terminal 3002 to compare the search keyword with the comparison keyword.

When the manual start module 44 is activated, and when comparison of the search keyword and the comparison keyword performed by the first comparison module 46 matches, the manual start module 44 displays a notice message on the display module 50 to inform a user to select an instruction for automatic execution of a corresponding mode or a direct listing instruction. When the user selects the automatic execution of a corresponding mode, the point-to-point distributive search and download system 30 executes the corresponding mode (will be discussed later). When the user selects the direct listing instruction, the point-to-point distributive search and download system 30 orders the second comparison module 48 to directly compare the search keyword with the catalog items opened by the catalog opening module 40 to enable the display module 50 to display the catalog items processed by the second comparison module 48 that contain the search keyword.

The second comparison module 48 is used on the search terminal 3002. When the comparison of the search keyword and the comparison keyword performed by the first comparison module 46 does not match, but the manual start module 44 controls the direct listing instruction, the second comparison module 48 compares the search keyword with the catalog items opened by the catalog opening module 40.

The display module 50 is used on the search terminal 3002. When the comparison of the search keyword and the text of the catalog items performed by the second comparison module 48 matches, the display module 50 displays the catalog items that contain the keyword on the Web browser 3402 on the display device 34. Each catalog item displayed by the display module 50 is linked through the network 3008 to the data terminal 3006 which contains the corresponding file of the catalog item. Once the user selects a catalog item, the file corresponding to the catalog item is downloaded through the download linking module 54 and the network.

The download determination module 52, link determination module 56 and listing determination module 60 are used on the search terminal 3002. When the comparison of the search keyword and the comparison keyword performed by the first comparison module 46 matches, the download determination module 52 compares the comparison keyword of the direct download mode which is the corresponding mode, the link determination module 56 compares the comparison keyword of the direct link mode which is the corresponding mode, and the listing determination mode 60 compares the comparison keyword of the direct listing mode which is the corresponding mode.

The download linking module 54 is used on the search terminal 3002. When the corresponding mode of the comparison keyword compared by the download determination module 52 is the direct download mode, the download linking module 54 is directly linked to the data terminal 3006 where the file corresponding to the comparison keyword resides, and the file is sent to the search terminal 3002 from the shared file catalog 41 of the data terminal 3006.

The Web link module 58 is used on the search terminal 3002. When the corresponding mode of the comparison keyword compared by the Web link module 58 is the direct link mode, it directly links the Web server 57 of a preset Web address corresponding to the comparison keyword, and downloads a Web database 59 from the Web server 57 to the corresponding Web page of the Web address, and displays the Web page on the display device 34 of the search terminal 3002.

When the corresponding mode of the comparison keyword compared by the listing determination module 60 is the direct listing mode, the comparison keyword is treated as the search keyword to be used by the second comparison module 48 to compare the comparison keyword with the catalog items opened by the catalog opening module 40. If the comparison of the comparison keyword and the text of the catalog items performed by the second comparison module 48 matches, the display module 50 displays the catalog items that contain the keyword on the Web browser 3402 of the display device 34. Each of the catalog items displayed by the display module 50 is linked through the network 3008 to the data terminal 3006 where the corresponding file of the catalog item resides. In the later stage, if selected by a user, the download link module 54 downloads the corresponding file of the selected catalog item from the shared file catalog 41.

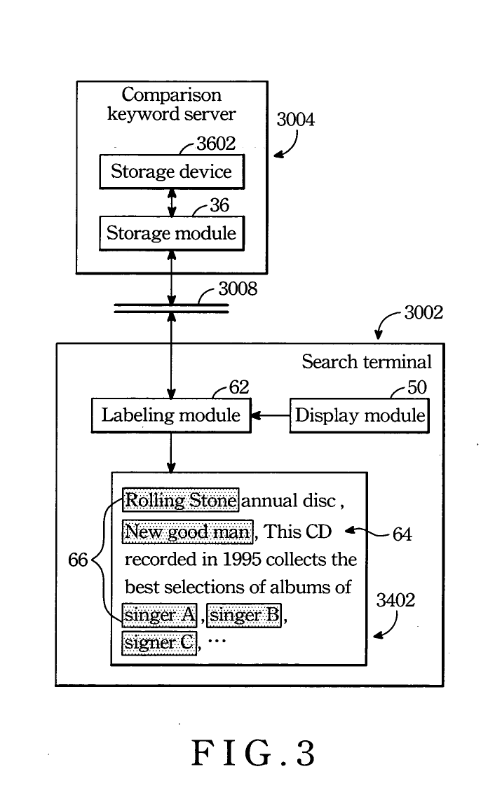

Referring to FIG. 3, the point-to-point distributive search and download system 30 further includes a labeling module 62. The labeling module 62 is used on the search terminal 3002. When the display module 50 displays a text 64 on the Web browser 3402, the labeling module 62 compares with the comparison keyword stored by the storage module 36 in advance in the storage device 3602 in the comparison keyword server 3004 through the network 3008, and marks and displays the comparison keyword 66 in the text 64.

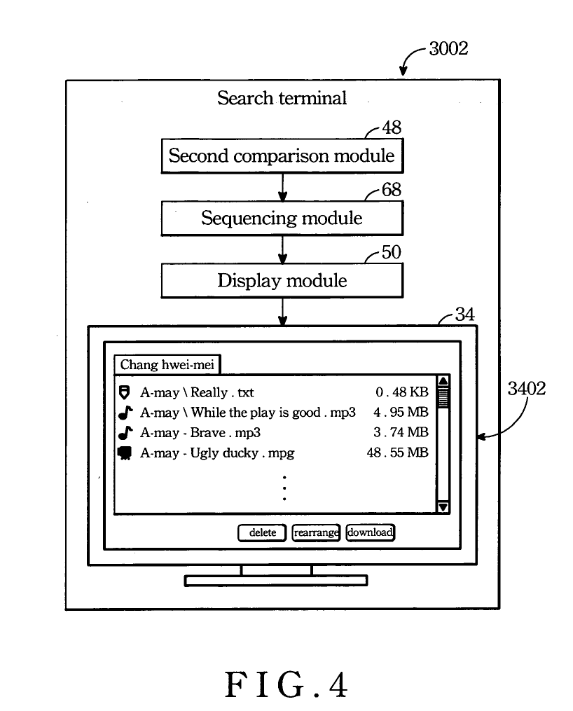

Referring to FIG. 4, the point-to-point distributive search and download system 30 further includes a sequencing module 68 in the search terminal 3002. It aims to arrange the catalog items according to a sequence principle to display the catalog items on the Web browser 3402 of the display device 34. The sequencing principle may be the fully downloaded frequency value of the files corresponding to the catalog items. After the download link module 54 has fully downloaded the files, the times of the files being downloaded in the latest time period are accumulated, such as the fully download times of each file in one month. The sequence of the catalog items corresponding to the files is arranged according to the corresponding times.

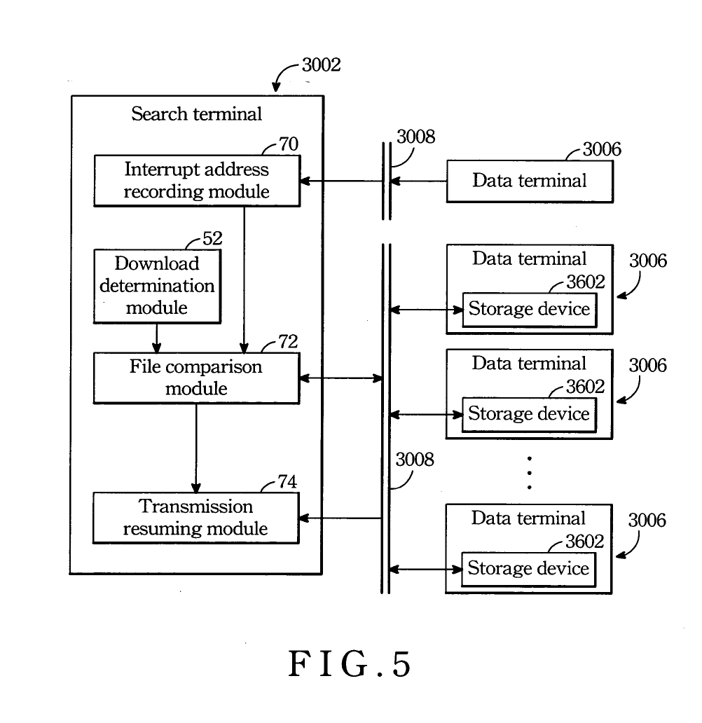

Refer to FIG. 5 for the process of resuming transmission after interruption occurred during file download process according to the invention. In the point-to-point distributive search and download system 30, the search and down macro module 32 further includes an interrupt address recording module 70, a file comparing module 72 and a transmission resuming module 74.

The interrupt address recording module 70 is used on the search terminal 3002. During download the file from the data terminal 3006 to the search terminal 3002, if interrupt occurs, the interrupt address is remembered according the sequence of the memory bit sequence of the file.

The file comparing module 72 is used on the search terminal 3002. When the data terminal 3006 to download the file through the download link module 52, it compares with the memory bit of the resuming download file in storage device 3602 of the data terminal 3006 through the network 3008 with the memory bit of the download interrupt file, and downloads the file only when the comparison matches.

The transmission resuming module 74 is used on the search terminal 3002. When the memory bits compared by the file comparing module 72 match, the interrupt address recording module 70 memorizes the memory bit after the file interrupt address, and file transmission is resumed from the storage device 3602 of the data terminal 3006 to the search terminal 3002.

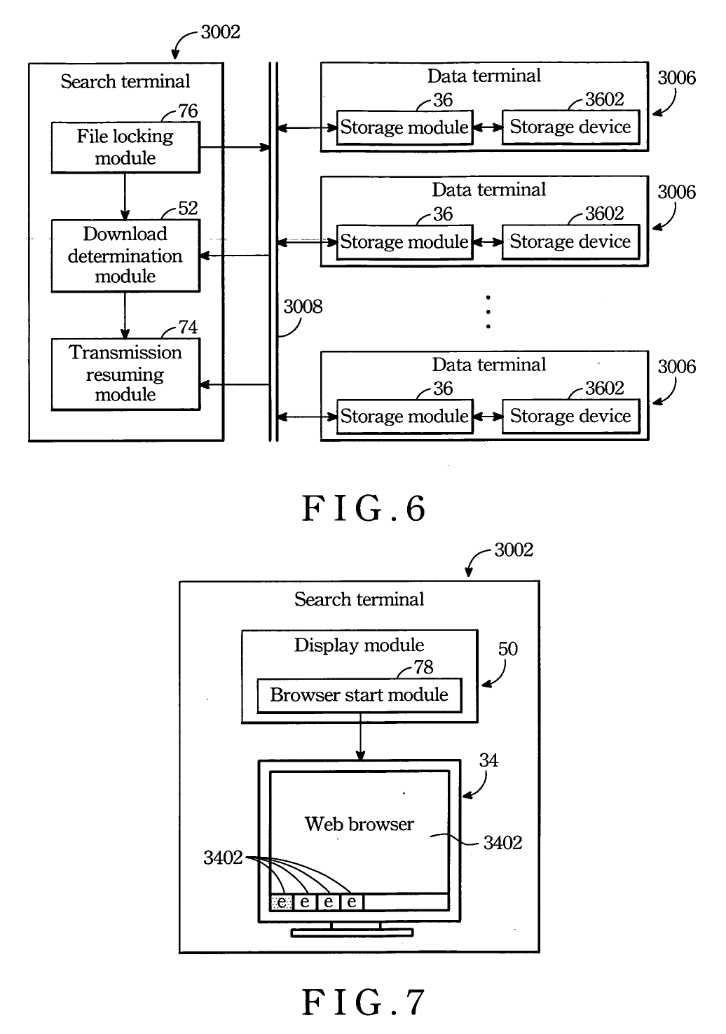

More about the point-to-point distributive search and download process are elaborated as follow. Refer to FIG. 6 for file downloading according to the invention. The point-to-point distributive search and download system 30 further includes a file locking module 76.

The file locking module 76 is connected to all of the data terminals 3006 where the files corresponding to the keyword reside to retrieve data from the files on the data terminals 3006, and construct the files on the search terminal 3002. Thereby data transmission can be achieved more efficiently.

The direct download mode previously discussed also is performed through the file locking module 76. The comparison keyword is directly linked to the data terminal 3006 where the file of file locking module 76 corresponding to the comparison keyword resides to enable the download determination nodule 52 to retrieve data from the file in the data terminal 3006 at later stage, and to construct the file on the search terminal 3002.

In addition, the file comparing module 72 compares the memory bit of the re-downloading file with the memory bit of the download interrupt file through the file locking module 76 to ensure that they are matched so that the transmission resuming module 74 retrieves the data of the file resided in the data terminal 3006 that is located after the memory bit of the interrupt address memorized by the interrupt address recording module 70, and resumes transmission to the search terminal 3002 to construct the file.

Refer to FIG. 7 for automatic starting of a new Web browser 3402 according to the invention. In the point-to-point distributive search and download system 30 previously discussed, the display module 50 further includes a browser starting module 78 used on the search terminal 3002. When the display module 50 displays the catalog items on the Web browser 3402, the browser starting module 78 starts a new Web browser 3402 first to enable the display module 50 to display the catalog items. Hence during the search process, different searches can initiate a plurality of Web pages at the same time so that new Web page does not overlap the old Web page on the same Web browser 3402. This function enables users to compare the results of different searches.

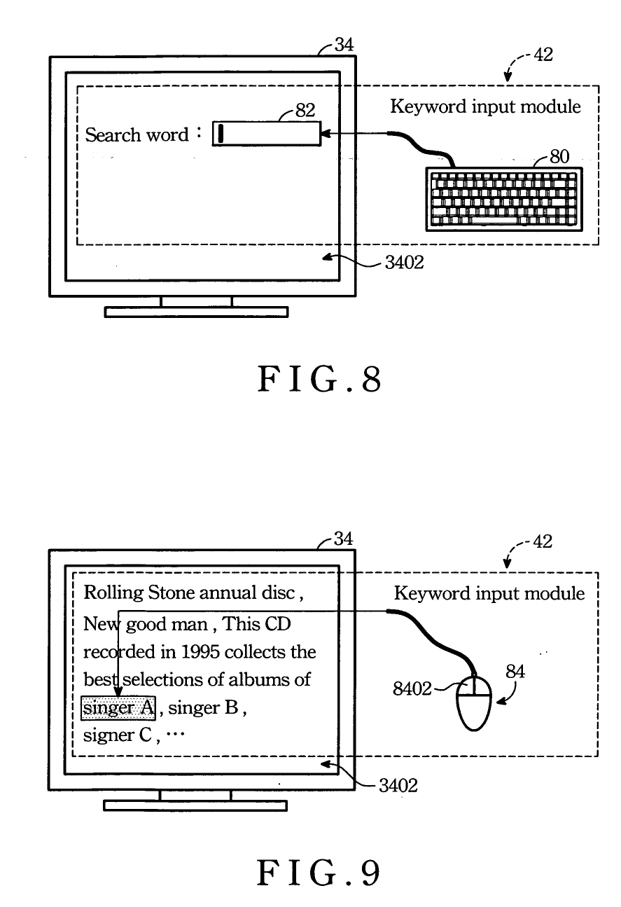

Refer to FIG. 8 for a first embodiment of the keyword input module 42 according to the invention. In the point-to-point distributive search and download system 30 previously discussed, the keyword input module 42 includes a text input pane 82 displayed by the Web browser 3402. By entering the search keyword through a keyboard 80, the corresponding entry will be shown on the text input pane 82. At present, most Web browsers adopt this mode.

Refer to FIG. 9 for a second embodiment of the keyword input module 42 according to the invention. In the point-to-point distributive search and download system 30 previously discussed, the keyword input module 42, through depressing a function key 8402 of a mouse 84 and moving the mouse 84, a paragraph of characters of the text displayed on the Web browser 3402 may be marked to become the search keyword. Thus the keyword can be generated without the trouble of entering character by character.

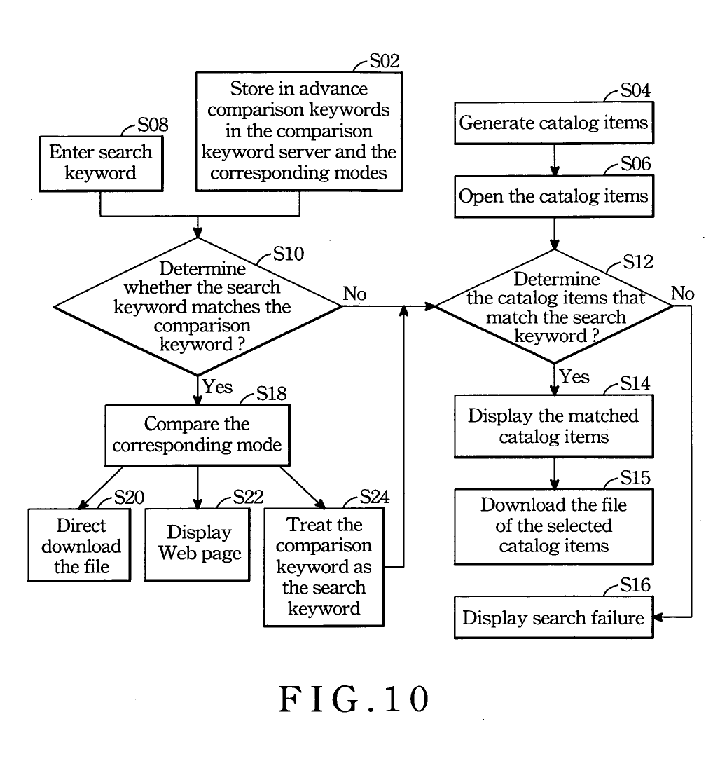

Refer to FIG. 10 for the process flow chart of the point-to-point distributive search and download method according to the invention. It is implemented on the point-to-point distributive search and download system 30 that uses the Web browser 3402 as an interface. The method includes the following steps:

Step S02: Store in advance at least one corresponding mode corresponding to a comparison keyword in the comparison keyword module 3004. The corresponding mode includes a direct download mode which directly links the comparison keyword to the data terminal 3006 where a file corresponding to the comparison keyword resides.

Step S04: The data terminal 3006 generates at least one catalog item according to the file resided therein.

Step S06: In the data terminal 3006, open the catalog item to the network 3008.

Step S08: On the search terminal 3002, enter a search keyword.

Step S10: In the search terminal 3002, compare the search keyword with the comparison keyword, and determine whether the search keyword and the comparison keyword match.

Step S12: In the search terminal 3002, when comparison of the search keyword and the comparison keyword does not match, compare the search keyword with the catalog items opened to the network 3008, and determine whether the catalog items and the search keyword match.

Step S14: In the search terminal 3002, when the comparison of the search keyword and the text of the catalog items matches, display the catalog items on the Web browser 3402 that contain the keyword. If the comparison of the search keyword and the text of the catalog items does not match, display a search failure message at step S16. Each catalog item being displayed is linked through the network 3008 to the data terminal 3006 where the corresponding file resides.

Step S15: Follow step S14. If the user selects one of the catalog items being displayed, it is linked to a plurality of data terminals 3006 where the files corresponding to the catalog item reside, and the files are downloaded respectively from the data terminals 3006 to the search terminal 3002 to construct the file.

Step S18: In the search terminal 3002, when the comparison of the search keyword and the comparison keyword at step S10 matches, compare to get the pre-stored corresponding mode corresponding to the comparison keyword.

Step S20: Following Step S18, when the corresponding mode corresponding to the comparison keyword is the direct download mode, directly link to the data terminal 3006 where the file corresponding to the comparison keyword resides, and transmit the file from the data terminal 3006 to the search terminal 3002 to construct the file.

Step S22: Following Step S18, when the corresponding mode corresponding to the comparison keyword is the direct link mode, link to the preset Web address corresponding to the comparison keyword, and display the Web page corresponding to the Web address on the search terminal 3002.

Step S24: Following step S18, when the corresponding mode corresponding to the comparison keyword is the direct listing mode, treat the comparison keyword as the search keyword to allow later process of step S12 to compare the comparison keyword with the catalog items opened to the network 3008. If the comparison of the comparison keyword and the text of the catalog items matches, display the catalog items that contain the keyword on the Web browser 3402. Each of the displaying catalog item is linked through the network 3008 to the data terminal 3006 where the file corresponding to the catalog item resides.

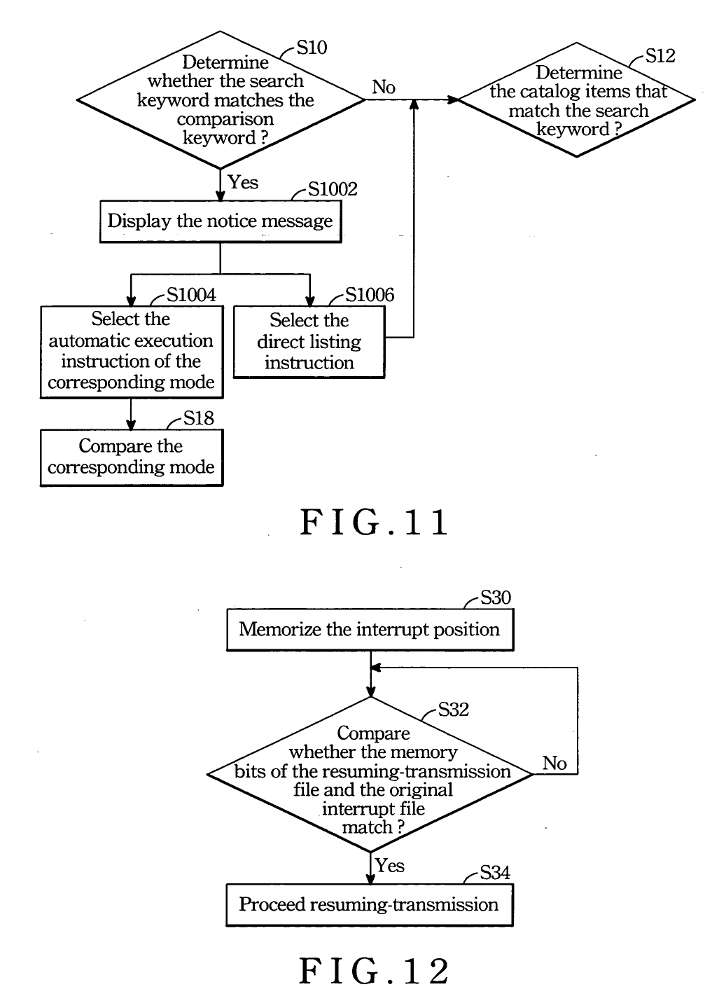

Refer to FIG. 11 for the process flow of step S10 previously discussed. It includes the following steps:

Step 1002: After the comparison of the search keyword and the comparison keyword matched, a notice message is sent to a user through the Web browser 3402. The notice message includes an instruction for automatic execution of a corresponding mode and a direct listing instruction.

Step 1004: Follow step 1002, select the instruction for automatic execution of a corresponding mode, The point-to-point distributive search and download method executes the corresponding mode corresponding to step S18 in the follow on process.

Step 1006: Follow step 1002, select the direct listing mode. After the user selects the instruction to execute direct listing, the point-to-point distributive search and download method executes step S12, and directly compares the search keyword with the catalog items opened on the network 3008 so that the catalog items corresponding to the search keyword are displayed through the Web browser 3402.

Refer to FIG. 12 for process flow of resuming process after interrupt according to the invention. It includes the following steps:

Step 30: At step S20 and S15 previously discussed, during the process of downloading the file from the data terminal 3006 to the search terminal 3002, if an interrupt occurs, memorize the interrupt address according to the sequence of the memory bit of the file.

Step 32: In the search terminal 3002, when to reselect the catalog item corresponding to the file which is interrupted during download, select the memory bit of the file corresponding to the catalog item that matches the memory bit of the file interrupted during download.

Step 34: in the search terminal 3002, when the comparison of the memory bit matches, resume transmission of the memory bits after the interrupt address of the file that has been memorized to the search terminal 3002.

It is to be noted that the modules previously discussed can be written in machine codes through C, VB or other assembly languages. And the machine codes may be stored in the memory to be executed by the processor to achieve the functions set forth above.

Thus by means of the point-to-point distributive search and download system 30 and method, and through the Web browser 3402 which serves as the interface, the point-to-point distributive search and download functions can be implemented easily. Moreover, it also can be expanded to include multiple process modes such as the direct download mode, direct link mode, direct listing mode and the like. Hence users and services providers can have multiple choices. Service items and business modes can be expanded. In addition, through the catalog generation module 38 and catalog opening module 40, other files may also be downloaded from the data terminal 3006.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A search and download macro module using a Web browser as an interface stored respectively in a search terminal and a data terminal, the search terminal, the data terminal and a comparison keyword server being interconnected through a network, the search and download macro module comprising:
a storage module located in the comparison keyword server to store at least one comparison keyword and a corresponding mode corresponding to the comparison keyword, the corresponding mode including a direct download mode to directly link to the data terminal where comprises a file corresponding to the comparison keyword resides;
a catalog generation module installed in the data terminal to generate at least one catalog item based on the file in the data terminal;
a catalog opening module installed in the data terminal to, open the catalog item to the network;
a keyword input module installed in the search terminal to enter a search keyword;
a first comparison module installed in the search terminal to compare the search keyword with the comparison keyword;
a second comparison keyword installed in the search terminal to compare the search keyword with the catalog item opened by the catalog opening module when the comparison of the search keyword and the comparison keyword performed by the first comparison module does not match;
a display module installed in the search terminal to display the catalog item which contains the keyword on the Web browser when the comparison of the search keyword and the text of the catalog item performed by the second comparison module matches, each catalog item displayed by the display module being linked through the network to the data terminal where the corresponding file of the catalog item resides;
a download determination module installed in the search terminal to compare the comparison keyword of the direct download mode which is the corresponding mode when the comparison of the search keyword and the comparison keyword performed by the first comparison module matches; and
a download linking module installed in the search terminal to directly link the data terminal where the corresponding file of the comparison keyword resides when the corresponding mode corresponding to the comparison keyword compared by the download determination module is the direct download mode, and transmit the file from the data terminal to the search terminal.

2. The search and download macro module of claim 1, the search and download macro module further including a labeling module installed in the search terminal to mark the comparison keyword in the text when the display module displays the text on the Web browser.

3. The search and download macro module of claim 1, wherein the corresponding mode further includes a direct link mode which directly links the comparison keyword to a preset set Web address, the search and download macro module further including:
a link determination module installed in the search terminal to compare with the comparison keyword when the corresponding mode is the direct link mode and the comparison of the search keyword and the comparison keyword performed by the first comparison module matches; and
a Web link module installed in the search terminal to directly link to a preset Web address corresponding to the comparison keyword when the corresponding mode of the comparison keyword compared by the Web link module is the direct link mode, and display a Web page corresponding to the Web address on the search terminal.

4. The search and download macro module of claim 3, wherein the corresponding mode further includes a direct listing mode, the point-to-point distributive search and download system further including:
a list determination module installed in the search terminal to compare the comparison keyword when the corresponding mode is the direct listing mode and the comparison of the search keyword and the comparison keyword performed by the first comparison module matches;
wherein when the corresponding mode of the comparison keyword compared by the list determination module is the direct listing mode, the comparison keyword is treated as the search keyword for the second comparison module to compare the comparison keyword and the catalog opening module to open the catalog item; when the comparison keyword and the text of the catalog item compared by the second comparison module match, the display module displays the catalog item which contains the keyword on the Web browser, each catalog item displayed by the display module being linked through the network to the data terminal where the file corresponding to the catalog item resides.

5. The search and download macro module of claim 4 further including a manual start module to display a notice message when started through the display module to a user when the comparison of the search keyword and the comparison keyword performed by the first comparison module matches, and to select an automatic execution instruction of a corresponding mode and a direct list instruction, search download macro module executing the corresponding mode after the user has selected the automatic execution instruction of the corresponding mode; when the user selects the direct listing instruction, the second comparison module directly compares the search keyword with the catalog item opened by the catalog opening module to allow the display module to display the catalog item which contains the search keyword compared by the second comparison module.

6. The search and download macro module of claim 1, wherein the search download macro module is computer executable machine codes and located outside the Web browser.

7. The search and download macro module of claim 6, wherein the search download macro module is transmitted through the network and installed in the search terminal and the data terminal.

8. The search and download macro module of claim 6, wherein the search download macro module is transmitted through a storage medium and installed in the search terminal and the data terminal.

9. The search and download macro module of claim 1, wherein the display module further includes a sequencing module to arrange the sequence of the catalog item according to a sequence principle for displaying the catalog item on the Web browser.

10. The search and download macro module of claim 9, wherein the sequence principle is the download frequency value of the file corresponding to the catalog item that has been fully downloaded.

11. The search and download macro module of claim 1 further including:
an interrupt address recording module installed in the search terminal to memorize an interrupt address according to the sequence of the memory bit of the file when an interrupt occurs while the data terminal downloads the file to the search terminal;
a file comparing module installed in the search terminal to compare and match the memory bit of a re-download file with the memory bit of the download interrupt file when the data terminal starts resuming download of the file; and
a transmission resuming module installed in the search terminal to resume transmission of the file to the search terminal that starts from the memory bit after the interrupt address memorized by the interrupt address recording module when the memory bits of the files compared by the file comparison module match.

12. The search and download macro module of claim 11 further including a file locking module to link to the data terminal where the file corresponding to the keyword resides so that data of the file are retrieved from the data terminal to allow the search terminal to construct the file.

13. The search and download macro module of claim 1, wherein the display module further includes a browser start module installed in the search terminal to start a new Web browser to display the catalog item when the display module displays the catalog item on the Web browser.

14. The search and download macro module of claim 1, wherein the keyword input module includes a text input pane displayed by the Web browser to display the search keyword entered through a keyboard.

15. The search and download macro module of claim 1, wherein the keyword input module marks the search keyword in the text displayed on the Web browser by depressing the function key of a mouse and moving the mouse.

16. The search and download macro module of claim 1, wherein the catalog opening module opens the catalog item to the network and places the catalog item in the comparison keyword server.

17. The search and download macro module of claim 1, wherein the catalog opening module opens the catalog item to the network and places the catalog item in other data terminals.

18. A point-to-point distributive search and download method using a Web browser as an interface including a search terminal, a comparison keyword server and at least one data terminal that are interconnected through a network, the method comprising the steps of:
storing in advance at least one comparison keyword in the comparison keyword server and a corresponding mode corresponding to the comparison keyword, the corresponding mode including a direct download mode which directly links the comparison keyword to the data terminal where a file corresponding to the comparison keyword resides;
generating at least one catalog item in the data terminal according to the file in the data terminal;
opening the catalog item from the data terminal to the network;
entering a search keyword from the search terminal;
comparing the search keyword with the comparison keyword on the search terminal;
comparing the search keyword with the catalog item opened to the network on the search terminal when the comparison of the search keyword and the comparison keyword does not match;
displaying the catalog item contained the keyword on the Web browser when the comparison of the search keyword and the catalog item matches, each catalog item being linked through the network to the data terminal where a file corresponding to the catalog item resides;
comparing the comparison keyword of the direct download mode which is the corresponding mode when the comparison of the search keyword and the comparison keyword matches, and
linking directly from the search terminal when the corresponding mode of the comparison keyword is the direct download mode to the data terminal where the file corresponding to the comparison keyword resides, and transmitting the file from the data terminal to the search terminal.

19. The method of claim 18, wherein the search terminal marks the comparison keyword in a text when the Web browser on the search terminal displays the text.

20. The method of claim 18, wherein the corresponding mode further includes a direct link mode to directly link the comparison keyword to a preset Web address, the method further including the steps of:
comparing the comparison keyword when the comparison mode is the direct link mode and the comparison of the search keyword and the comparison keyword matches; and
linking directly from the search terminal when the corresponding mode of the comparison keyword is the direct link mode to a preset network address, and displaying a Web page corresponding to the Web address on the search terminal.

21. The method of claim 20, wherein the corresponding mode further includes a direct listing mode, the method further including the steps of:
comparing the comparison keyword when the comparison mode is the direct listing mode and the comparison of the search keyword and the comparison keyword matches;
wherein when the corresponding mode of the comparison keyword is the direct listing mode, the comparison keyword is treated as the search keyword for comparing the comparison keyword with catalog item opened to the network; when the comparison keyword and the text of the catalog item matches, the catalog item contained the keyword is displayed on the Web browser, each displayed catalog item being linked through the network to the data terminal where the file corresponding to the catalog item resides.

22. The method of claim 21 further including the steps of: displaying a notice message to a user when the comparison of the search keyword and the comparison keyword matches, and selecting an automatic execution instruction of a corresponding mode and a direct listing instruction, the point-to-point distributive search and download method executing the corresponding mode after the user having selected the automatic execution instruction of the corresponding mode; when the user selects the direct listing instruction, the method directly compares the search keyword with the catalog item opened to the network to display the catalog item that contains the search keyword through the Web browser.

23. The method of claim 18, wherein the steps are executed through a search download macro module.

24. The method of claim 23, wherein the search download macro module is computer executable machine codes and located outside the Web browser.

25. The method of claim 24, wherein the search download macro module is transmitted through the network and installed in the search terminal and the data terminal.

26. The method of claim 25, wherein the search download macro module is transmitted through a storage medium and installed in the search terminal and the data terminal.

27. The method of claim 18 further including a sequencing module to arrange the sequence of the catalog item according to a sequence principle for displaying the catalog item on the Web browser.

28. The method of claim 27, wherein the sequence principle is the download frequency value of the file corresponding to the catalog item that has been fully downloaded.

29. The method of claim 23 further includes the steps of:
memorizing an interrupt address from the search terminal according to the sequence of memory bits of the file when an interrupt occurs while the file is downloaded from the data terminal to the search terminal;
comparing on the search terminal memory bits of the file corresponding the catalog item being selected to match the memory bits of the download interrupt file when the download interrupt file corresponding to the catalog item is selected again; and
resuming transmission of memory bits after the memorized interrupt address to the search terminal when the comparison of the memory bits matches.

30. The method of claim 29 further including linking to the data terminal where the file corresponding to the keyword resides so that data of the file are retrieved from the data terminal to allow the search terminal to construct the file.

31. The method of claim 18 further including opening a new Web browser on the search terminal when the catalog item is displayed on the Web browser to allow the Web browser to display the catalog item.

32. The method of claim 18, wherein the Web browser includes a text input pane to display the search keyword entered through a keyboard.

33. The method of claim 18, wherein the search keyword displayed on the Web browser is marked by depressing the function key of a mouse and moving the mouse.

34. The method of claim 18, wherein the catalog item is located in the comparison keyword server after the catalog item has been opened to the network.

35. The method of claim 18, wherein the catalog item is located in other data terminals after the catalog item has been opened to the network.
